(19) United States
(12) Patent Application Publication
(10) Pub. No.: US 2014/0028795 A1
(43) Pub. Date: Jan. 30, 2014

(54) Image Processing Method and Image Displaying system

(71) Applicant: NOVATEK MICROELECTRONICS CORP., Hsin-Chu (TW)

(72) Inventors: Jiande Jiang, Xi'an (CN); CHUN WANG, Shanghai (CN)

(73) Assignee: NOVATEK MICROELECTRONICS CORP., Hsin-Chu (TW)

(21) Appl. No.: 13/659,922

(22) Filed: Oct. 25, 2012

(30) Foreign Application Priority Data
Jul. 27, 2012 (CN) 201210263915.2

(51) Int. Cl. H04N 13/00

(52) U.S. Cl. 348/43; 348/E13.068

(57) ABSTRACT

An image processing method is disclosed, which includes receiving an image data of an image frame and dividing the image data into first image data corresponding to a 2D image and second image data corresponding to a 3D image, converting the first image data into 2D image data according to a 2D image format and converting the second image data into 3D image data according to a 3D image format, and outputting the 2D image data and the 3D image data for displaying the image frame.

### BACKGROUND OF THE INVENTION

1. Field of the Invention

The present invention relates to an image processing method and an image displaying system, and more particularly, to an image processing method and an image displaying system capable of avoiding degrading two-dimensional (2D) image resolution of the image frame.

2. Description of the Prior Art

Web TV combines functions of network information communication and multimedia displaying. Through the Web TV, users can simultaneously acquire numerous and the latest videos and the network information. Therefore, the users can enjoy the desired videos as they want and are not limited to access videos via a broadcasting TV or a CD storage device.

Generally, a client end of the Web TV utilizes an image receiving device for receiving image data from the content provider. The image receiving device converts the received image data to displaying signals conformed to the displaying device, for displaying the image. Due to the diversity of the applications of the Web TV, the image data generally include various types of image, such as Web page, Graphical User Interface (GUI), On Screen Display (OSD) and video. For example, if the client end wants to watch a video on a certain Web page and the video is displayed in a small window of a multimedia player software, the image frame viewed by the user includes a web page image and a video image. After the image receiving device of the client receives related image data of the Web page image and the video image, the image receiving device would execute overlay processing on the Web page image and the video image for combining the image frame. Meanwhile, the image receiving device also converts the image frame to signals capable of displaying by the displaying device, so as to display the image frame on the displaying device. When the image frame includes a three-dimensional (3D) image, the image receiving device of the client has to convert the received image data according to 3D image format for generating 3D image signal in corresponding image format. As such, the image displayed on the displaying device can provide images with 3D effect to the user.

For example, please refer to FIG. 1, an image frame F includes a Web page image and a video image. The Web page image is a 2D image and the video image is a 3D image in the side-by-side image format. After receiving first image data S1 corresponding to the Web page image and second image data S2 corresponding to the video image, the image processing device converts the first image data S1 and the second image data S2 according to the 3D image format for generating image data conformed to the side-by-side image format. In other words, the image data S1 is divided to image data S1_L and S1_R in the side-by-side image format and the image data S2 is also divided to image data S2_L and S2_R in the side-by-side image format. Next, the post-stage image displaying chip generates corresponding left-eye images and right-eye images according to the displaying type of the displaying device, for displaying the image frame on the displaying device. For example, when the displaying device is a displaying device with shutter glasses (SG) type, the image data S1_L, S1_R, S2_L and S2_R would be extended in horizontal direction for generating the corresponding left-eye images and right-eye images (i.e. images S_2DL, S_2DR, S_3DL, S_3DR) . The images S_2DL, S_2DR, S_3DL and S_3DR are alternately displayed for displaying the image frame. As a result, the user can view the vivid 3D image video.

However, the converting of the side-by-side image format would halve the resolution of images. In other words, the horizontal resolution of images is halved. For the Web page image S_2D belonging to the 2D image, half of the resolution is sacrificed. In such a condition, although the user can see the video image S_3D with 3D effect, the displayed Web page image would be distorted because the resolution of the Web page image is halved, such that the quality of displaying is degraded.

### SUMMARY OF THE INVENTION

Therefore, the present invention provides an image processing method and an image displaying system to fix the issue of decreasing the 2D image resolution in the image frame.

The present invention discloses an image processing method. The image processing method includes receiving image data of an image frame and dividing the image data into first image data related to 2D images and second image data related to 3D images; converting the first image data to 2D image data according to a 2D format and converting the second image data to 3D image data according to a 3D format; and outputting the 2D image data and the 3D image data, for displaying the image frame.

The present invention further discloses an image displaying system. The image displaying device includes a determining unit, for receiving image data of an image frame and dividing the image data into first image data related to 2D images and second image data related to 3D images; a format converting unit, for converting the first image data to a 2D image data according to a 2D image format and converting the second image data to a 3D image data according to a 3D image format; and an image outputting unit, for converting the 2D image data and the 3D image data to 2D displaying image and a 3D displaying image, respectively, according to a displaying type.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of operations of conventional image display processing.

FIG. 2 is a schematic diagram of an image displaying system according to an embodiment of the present invention.

FIG. 3 is a schematic diagram of determining image displaying position according to an embodiment of the present invention.

FIG. 4 and FIG. 5 respectively are schematic diagrams of exemplary embodiments when the image displaying system shown in FIG. 2 processes images.

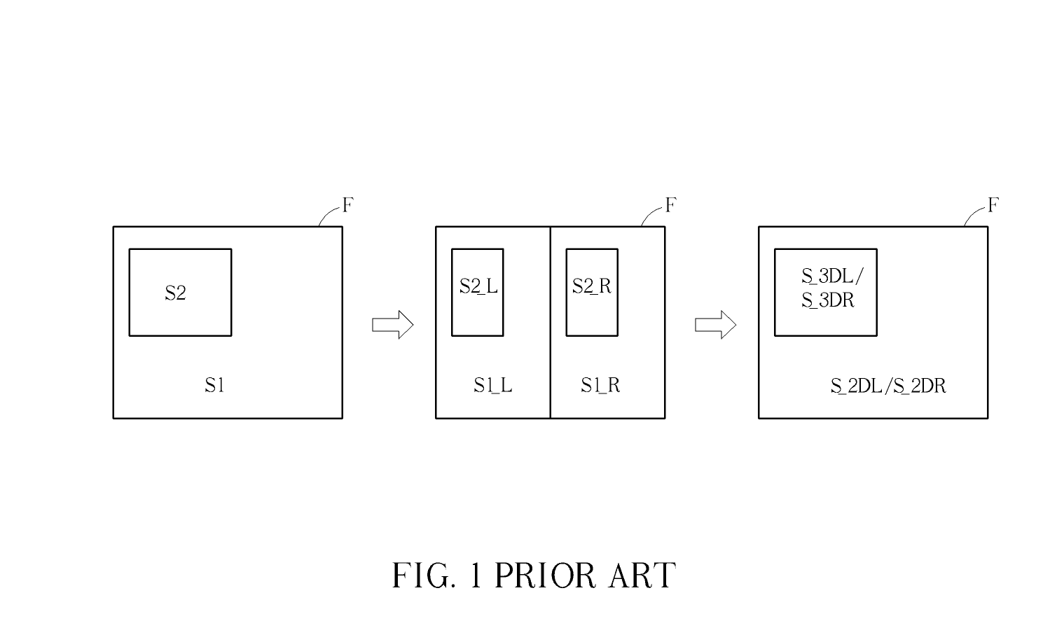

### DETAILED DESCRIPTION

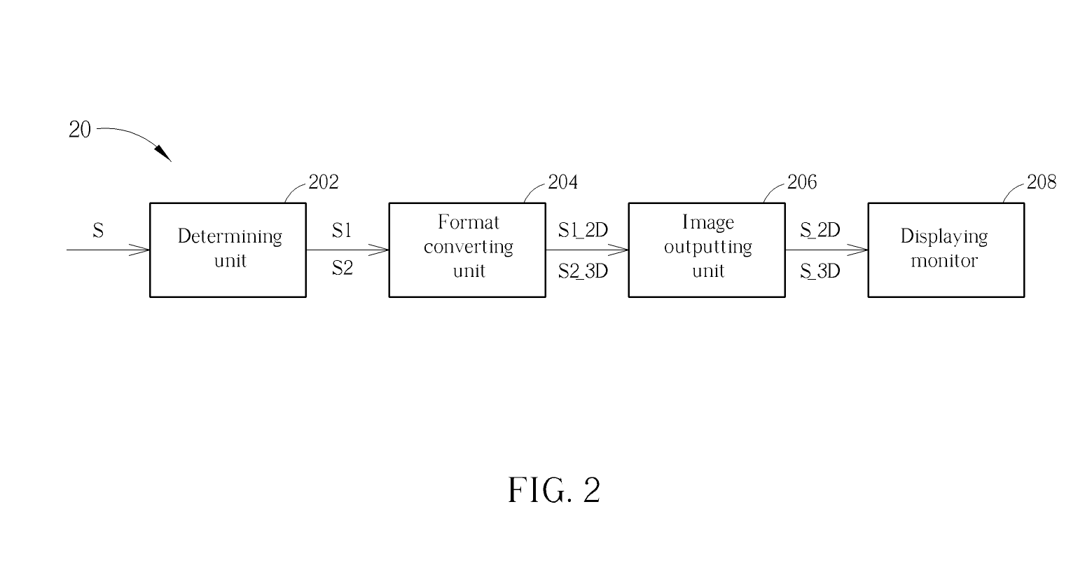

Please refer to FIG. 2, which is a schematic diagram of an image displaying system 20 according to embodiment of the present invention. The image displaying system 20 includes a determining unit 202, a format converting unit 204, an image outputting unit 206 and a displaying monitor 208. The determining unit 202 is utilized for receiving image data S of an image frame F and dividing the image data S to first image data S1 related to 2D images and second image data S2 related to 3D images. The image frame F may be the image frame provided by the content provider of a transmitting end. The format converting unit 204 is utilized for converting the first image data S1 to 2D image data S1_2D according to a 2D image format. Meanwhile, the format converting unit 204 converts the second image data S2 to 3D image data S2_3D according to a 3D image format. For example, the 3D image format may be a side-by-side image format or a top-bottom image format, but is not limited herein. The image outputting unit 206 is utilized for converting the 2D image data S1_2D to 2D displaying image S_2D and converting the 3D image data S2_3D to 3D displaying image S_3D according to the displaying type of the displaying monitor 208. The displaying monitor 208 is utilized for displaying the 2D displaying image S_2D and the 3D displaying image S_3D outputted by the image outputting unit 206, to display image frame F. For example, the displaying type of the displaying monitor 208 may be a shutter glasses type or a patterned retarder type, but is not limited herein.

In brief, after the image displaying system 20 receives the image data transmitted by the transmitting end, the determining unit 202 distinguishes the image data belonging to the 2D images and the image data belonging to the 3D images. Then, the format converting unit 204 performs format conversion on the image data according to corresponding image transmitting format. As a result, the 3D images would have 3D effect and the 2D images would keep the original resolution, so as to avoid image distortion due to the halved resolution.

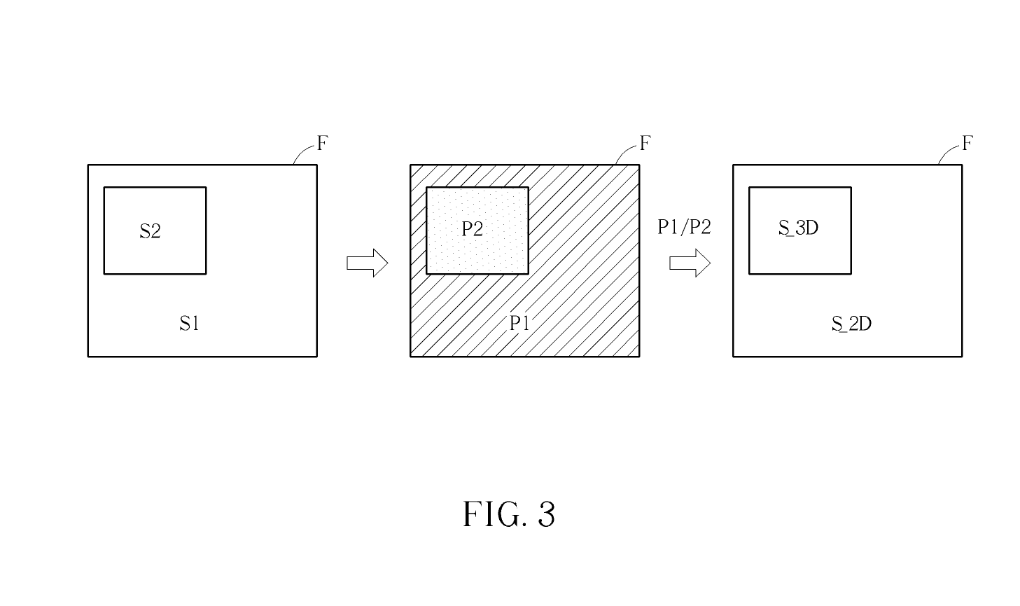

On the other hand, the determining unit 202 further determines a displaying position P1 corresponding to the first image data S1 and a displaying position P2 corresponding to the second image data S2. For example, please refer to FIG. 3 which is schematic diagram of determining image displaying positions according to an embodiment of the present invention. After receiving the image data S of the image frame F and dividing the image data S to the first image data S1 and the second image data S2, the determining unit 202 determines the displaying position P1 and the displaying position P2 according to the received image data S. Or, the determining unit 202 may determine the displaying position P1 and the displaying position P2 via analyzing image position information transmitted from the transmitting end. Next, the information of the displaying position P1 and the displaying position P2 are provided to the image outputting unit 206. In such a condition, the image outputting unit 206 would accordingly arrange the image frame for displaying the 2D displaying image S_2D at the displaying position P1 of the image frame F and displaying the 3D displaying image S_3D at the displaying position P2 of the image frame F, so as to display each sub-frame at accurate position of the image frame F.

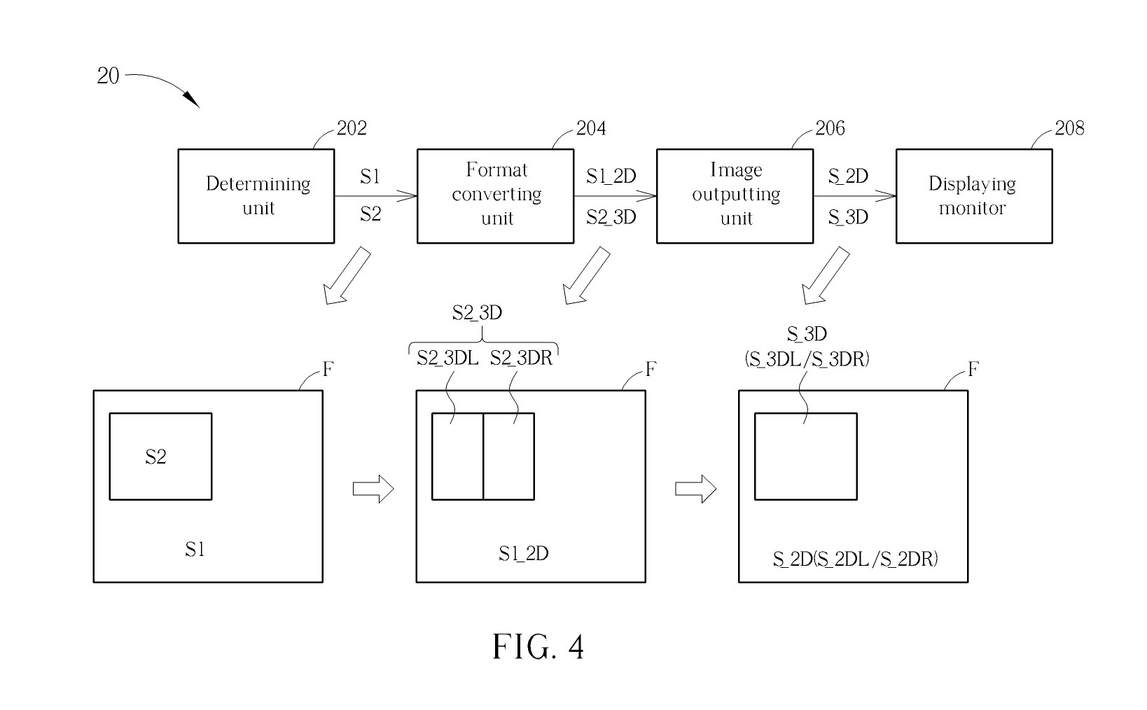

In this embodiment, the user can use image displaying system 20 for processing the received image data, to prevent the resolution of 2D images from being degraded and to achieve excellent displaying quality. For example, please refer to FIG. 4 which is a schematic diagram of an exemplary embodiment when the image displaying system 20 shown in FIG. 2 processes images. When the user is watching a 3D video on a certain Web page, the image frame F would include a Web page image of the Web page displayed by the Web browser and a video image displayed in the small window of the multimedia player software. In other words, the image frame F viewed by the user includes a Web image (2D image) and a video image (3D image). In this embodiment, the transmitting end (i.e. content provider) transmits the video image in the side-by-side image transmitting format. In such a condition, after the determining unit 202 of the image displaying system 20 receives the image data S of the image frame F, the determining unit 202 determines the first image data S1 belonging to the 2D image and the second image data S2 belonging to the 3D image. Next, the format converting unit 204 converts the first image data S1 to 2D image data S1_2D according to the 2D image format. Meanwhile, since the transmitting end transmits the video image in the side-by-side image transmitting format, the format converting unit 204 converts the second image data S2 to 3D image data S2_3D according to the side-by-side image transmitting format. In other words, the format converting unit 204 divides the second image data S2 to 3D image data S2_3DL and S2_3DR.

Next, the image outputting unit 206 converts the 2D image data S1_2D and the 3D image data S2_3D to the corresponding 2D displaying image S_2D and the corresponding 3D displaying image S_3D, respectively, according to the displaying type of the displaying monitor 208. If the displaying monitor 208 is the shutter glasses type display, the image outputting unit 206 would extend the 3D image data S2_3DL and S2_3DR twice in horizontal direction (i.e. enlarge the 3D image data S2_3DL and S2_3DR twice in horizontal direction), for generating the corresponding 3D displaying images S_3DL and S_3DR (i.e. the 3D displaying image S_3D includes the 3D displaying images S_3DL and S_3DR). Meanwhile, the image outputting unit 206 converts the 2D image data S1_2D to the corresponding 2D displaying image S_2D, which includes a 2D displaying image S_2DL and a 2D displaying image S_2DR. The 2D displaying image S_2DL and the 2D displaying image S 2DR are the left-eye image data and the right-eye image data, respectively. Also, the 3D displaying images S_3DL and S_3DR are respectively the left-eye image data and the right-eye image data. Since the 2D image data S1_2D is not divided, the resolution of the 2D displaying image S_2D remains the same. Finally, the image outputting unit 206 provides the 3D displaying image S_3DL, the 3D displaying image S_3DR, the 2D displaying image S_2DL and the 2D displaying image S_2DR to the displaying monitor 208, for displaying the image frame F through alternately displaying the left-eye image data and the right-eye image data. Similarly, if the displaying type of the displaying monitor 208 is patterned retarder type display, the image outputting unit 206 extends the 3D image data S2_3DL and S2_3DR twice in the horizontal direction (i.e. enlarge the 3D image data S2_3DL and S2_3DR twice in the horizontal direction) and shrink the 3D image data S2_3DL and S2_3DR twice in the vertical direction. Then, the image outputting unit 206 performs line-by-line interleave on the 3D image data S2_3DL and S2_3DR, for generating the corresponding 3D displaying images S_3DL and S_3DR (i.e. the 3D displaying image S_3D includes the 3D displaying images S_3DL and S_3DR).

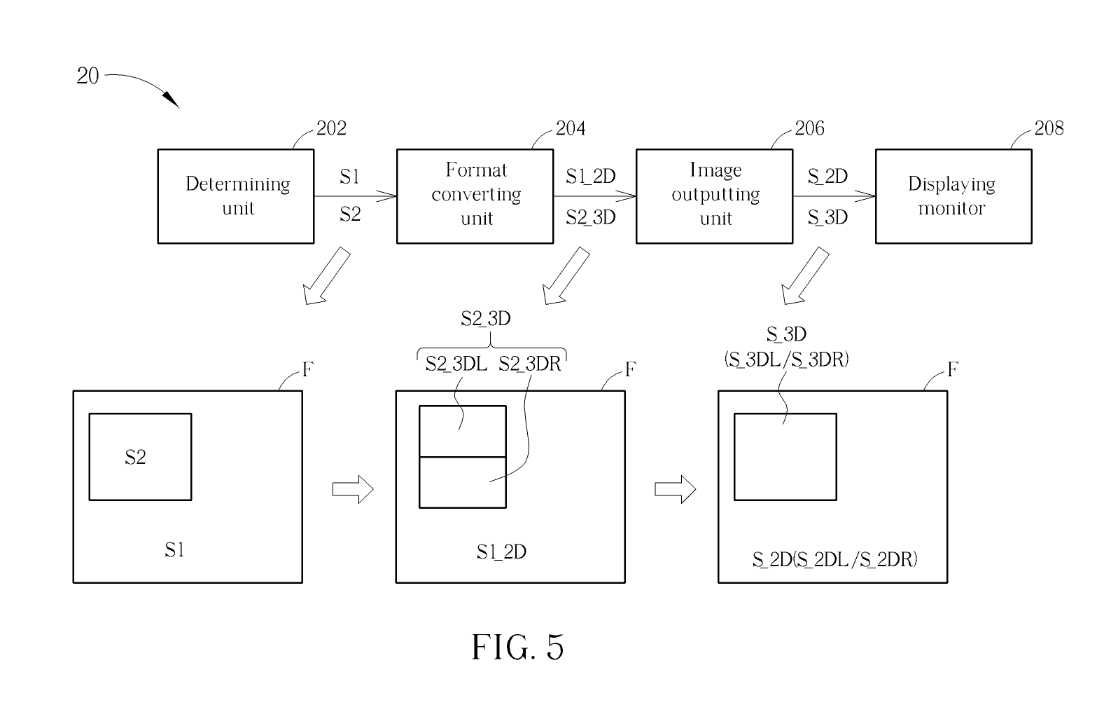

Please refer to FIG. 5, which is a schematic diagram of another exemplary embodiment when the image displaying system 20 shown in FIG. 2 processes images. The embodiment shown in FIG. 5 is based on transmitting video in top-bottom image transmitting format from the transmitting end. Similarly, the image frame watched by the user includes a Web image (2D image) and a video image (3D image). After the determining unit 202 of the image displaying system 20 receives the image data S of the image frame F, the determining unit 202 determines the first image data S1 belonging to the 2D image and the second image data S2 belonging to the 3D image. Next, the format converting unit 204 converts the first image data S1 to 2D image data S1_2D according to the 2D image format. Meanwhile, since the transmitting end transmits the video image in the top-bottom image transmitting format, the format converting unit 204 converts the second image data S2 to 3D image data S2_3D according to the top-bottom image transmitting format. In other words, the format converting unit 204 divides the second image data S2 to 3D image data S2_3DL and S2_3DR.

Similarly, the image outputting unit 206 converts the 2D image data S1_2D and the 3D image data S2_3D to the corresponding 2D displaying image S_2D and the corresponding 3D displaying image S_3D, respectively, according to the displaying type of the displaying monitor 208. If the displaying monitor 208 is the shutter glasses type display, the image outputting unit 206 would extends the 3D image data S2_3DL and S2_3DR twice in vertical direction (i.e. enlarge the 3D image data S2_3DL and S2_3DR twice in vertical direction), for generating the corresponding 3D displaying images S_3DL and S_3DR (i.e. the 3D displaying image S_3D). Meanwhile, the image outputting unit 206 converts the 2D image data S1_2D to the corresponding 2D displaying image S_2D, which includes 2D displaying images S_2DL and S_2DR. The 2D displaying images S_2DL and S_2DR are the left-eye image data and the right-eye image data, respectively. Also, the 3D displaying images S_3DL and S_3DR are respectively the left-eye image data and the right-eye image data. Since the 2D image data S1_2D is not divided, the resolution of the 2D displaying image S_2D remains the same. Finally, the image outputting unit 206 provides the 3D displaying image S_3DL, the 3D displaying image S_3DR, the 2D displaying image S_2DL and the 2D displaying image S_2DR to the displaying monitor 208, for displaying the image frame F through alternately displaying the left-eye image data and the right-eye image data. Similarly, if the displaying type of the displaying monitor 208 is patterned retarder type display, the image outputting unit 206 extends the 3D image data S2_3DL and S2_3DR twice in the vertical direction (i.e. enlarge the 3D image data S2_3DL and S2_3DR twice in the vertical direction) and shrink the 3D image data S2_3DL and S2_3DR twice in the horizontal direction. Then, the image outputting unit 206 performs line-by-line interleave on the 3D image data S2_3DL and S2_3DR, for generating the corresponding 3D displaying images S_3DL and S_3DR (i.e. the 3D displaying image S_3D includes the 3D displaying images S_3DL and S_3DR). In brief, the image displaying system 20 can distinguish the 2D images and the 3D images and can convert the 2D images and the 3D images according to the image transmitting format. As a result, the 2D images and the 3D images of the image frame F can be displayed without distortion, so as to avoid degrading the resolution of the 2D images in the image frame.

Noticeably, the embodiment shown in FIG. 2 is only an embodiment of the present invention. All kinds of alternation according to the embodiment shown in FIG. 2 belong to the concept of the present invention. For example, the above embodiment uses a 3D image block and a 2D image block as example for simplicity. However, the image displaying system 20 can process the image frame with one or more 3D blocks. Besides, the determining unit 202 and the format converting unit 204 can be configured in a video receiving device, such as a system-on-chip of a set-top box. The image outputting unit 206 may be configured in a displaying device, such as a controlling chip of a liquid crystal display TV, but is not limited herein.

To sum up, the image display system of the present invention can distinguish the 2D images and the 3D images of the image frame transmitted by the transmitting end, and can convert the image data according to corresponding image transmitting format. As a result, the 3D images would have 3D effect and the resolution of the 2D images would remain the same. Therefore, the distortion caused by the halved resolution is effectively avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
receiving image data of an image frame and dividing the image data into first image data related to 2D images and second image data related to 3D images;
converting the first image data to 2D image data according to a 2D format and converting the second image data to 3D image data according to a 3D format; and
outputting the 2D image data and the 3D image data, for displaying the image frame.

2. The image processing method of claim 1, wherein the step of dividing the image data into the first image data related to the 2D images and the second image data related to the 3D images further comprises:
determining a first displaying position corresponding to the first image data and a second displaying position corresponding to the second image data.

3. The image processing method of claim 2, wherein the step of outputting the 2D image data and the 3D image data for displaying the image frame further comprises:
displaying the 2D image data at the first displaying position of the image frame; and
displaying the 3D image data at the second displaying position of the image frame.

4. The image processing method of claim 1, wherein the step of outputting the 2D image data and the 3D image data for displaying the image frame comprises:
converting the 2D image data and the 3D image data to a 2D display image and a 3D display image, respectively, according to a displaying type of a displaying monitor; and
displaying the 2D display image and the 3D display image on the displaying monitor for displaying the image frame.

5. The image processing method of claim 1, wherein the 3D format is a side-by-side image format or a top-bottom image format.

6. An image displaying system, comprising:
a determining unit, for receiving image data of an image frame and dividing the image data into first image data related to 2D images and second image data related to 3D images;
a format converting unit, for converting the first image data to 2D image data according to a 2D image format and converting the second image data to 3D image data according to a 3D image format; and
an image outputting unit, for converting the 2D image data and the 3D image data to a 2D displaying image and a 3D displaying image, respectively, according to a displaying type.

7. The image displaying system of claim 6, wherein the determining unit determines a first displaying position corresponding to the first image data and a second displaying position corresponding to the second image data.

8. The image displaying system of claim 7, wherein the image outputting unit converts the 2D image data and the 3D image data to the 2D displaying image and the 3D displaying image, respectively, according to the first displaying position, the second displaying position and the displaying type, for displaying the 2D displaying image at the first displaying position and displaying the 3D displaying image at the second displaying position.

9. The image displaying system of claim 6, wherein the 3D image format is a side-by-side image format or a top-bottom image format.
